(19) United States
(12) Patent Application Publication
(10) Pub. No.: US 2018/0219415 A1
(43) Pub. Date: Aug. 2, 2018

(54) INDUCTIVE POWER TRANSMITTER AND METHOD OF POWER FLOW CONTROL

(71) Applicant: Apple Inc., Cupertino, CA (US)

(72) Inventor: Saining REN, Freemans Bay, Auckland (NZ)

(21) Appl. No.: 15/537,139

(22) PCT Filed: Dec. 16, 2015
(86) PCT No.: PCT/NZ2015/050214

§ 371 Date: Jun. 16, 2017

Related U.S. Application Data
(60) Provisional application No. 62/093,598, filed on Dec. 18, 2014.

(51) Int. Cl. H02J 50/10; H01F 38/14; H02J 7/00

(52) U.S. Cl. CPC H02J 50/10; H02J 7/007; H01F 38/14

(57) ABSTRACT

An inductive power transmitter 2 comprising: a controllable DC voltage source 5; a DC-AC converter 6 that receives a DC power supply from the controllable DC voltage source 5 and generates an AC output waveform to drive a transmitter coil 7 of an inductive power transfer system 1; a current sensor 9 for measuring the current supplied by the controllable DC voltage source 5 to the DC-AC converter 6; and a controller 8 that adjusts the output voltage of the DC voltage source 5 based on the current measured by the current sensor 9.

### FIELD

This invention relates generally to an inductive power transmitter, particularly, but not exclusively, for an inductive power transfer system and a method of power flow control.

### BACKGROUND

IPT (inductive power transfer) systems are a well-known area of established technology (for example, wireless charging of electric toothbrushes) and developing technology (for example, wireless charging of handheld devices on a ‘charging mat’). In any IPT system some form of power flow control is required for efficient operation and there are trade-offs as to system complexity and performance.

Traditionally, reactive power supply in an IPT transmitter has been predetermined by the design of the circuit with a fixed load at the secondary circuit.

Systems having no IPT transmitter side power flow control with IPT receiver side power flow control result in low system efficiency as the IPT transmitter operates so as to meet full power demand from the IPT receiver at any time.

Systems having IPT transmitter side power flow control with no IPT receiver side power flow control may be achieved using a range of approaches including changing the inverter operating frequency, power supply to the inverter or the duty cycle of the switched inverter output waveform based on measured electrical parameters on the transmitter side. However power flow control on only the IPT transmitter side results in discontinuity of power supply as there is lag in the IPT transmitter side prediction of power demand by the IPT receiver side and power flow control in the IPT transmitter side.

Good power flow control can be achieved where there is communication between the transmitter and receiver but this adds cost and complexity to a system.

The invention provides an inductive power transfer system and a method of power flow control that achieves good power flow control utilising a relatively simple design or at least provides the public with a useful choice.

### SUMMARY

According to one example embodiment there is provided an inductive power transmitter comprising:
a. a controllable DC voltage source;
b. a DC-AC converter that receives a DC power supply from the controllable DC voltage source and generates an AC output waveform to drive a transmitter coil of an inductive power transfer system;
c. a current sensor for measuring the current supplied by the controllable DC voltage source to the DC-AC converter; and
d. a controller that adjusts the output voltage of the DC voltage source based on the current measured by the current sensor.

There is further provided a method of controlling an inductive power transmitter supplying power to an inductive power receiver, wherein the inductive power transmitter includes a DC-AC converter driving a transmitter coil from a controllable DC voltage source and wherein the inductive power receiver has power flow control, the method including the steps of:
a. monitoring the current output by the controllable DC voltage source; and
b. controlling the voltage output by the controllable DC voltage source based on the monitored current such that the transmitted power is calculated to be a margin greater than the power required by the inductive power receiver.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a schematic diagram of an inductive power transfer system; and

FIG. 2 is a circuit diagram including a DC-AC converter design according to one embodiment.

### DETAILED DESCRIPTION

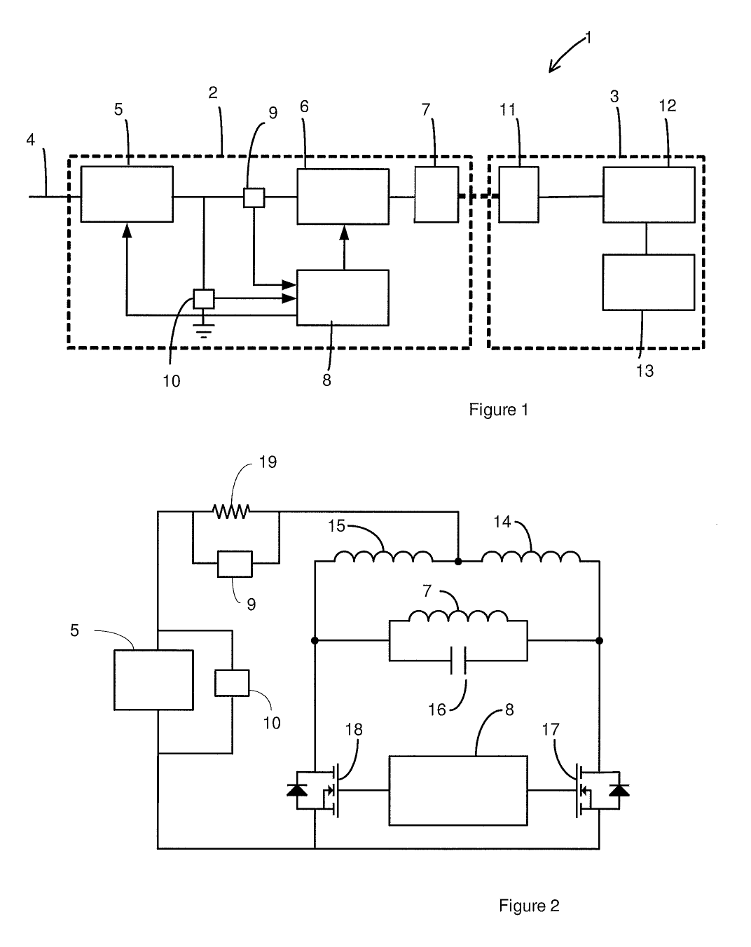

Referring to FIG. 1 a schematic diagram of an inductive power transfer system 1 is shown including an IPT transmitter 2 and an IPT receiver 3. The transmitter 2 includes a controllable DC voltage source 5, which in this case is a DC-DC converter receiving a DC input supply 4. DC voltage source 5 may be a Buck or Buck-boost converter, however, a Buck-boost converter is preferred as it is able to work over a large input voltage range The controllable DC voltage source 5 provides a regulated DC output voltage to DC-AC converter 6 (suitably operating in boost mode) that drives transmitter coil 7. In a physical realisation the DC-AC converter may incorporate the controllable DC voltage source. Current sensor 9 measures the current supplied by controllable DC voltage source 5 to DC-AC converter 6 and voltage sensor 10 measures the output voltage of controllable DC voltage source 5. Controller 8 (a suitable micro-controller) receives this information from sensors 9 and 10 and controls the output voltage of controllable DC voltage source 5 accordingly. Controller 8 also controls the switching of DC-AC converter 6.

IPT receiver 3 includes a receiver coil 11 that supplies power to a rectifier 12 which in turn supplies power to a power flow controller 13 which in this case is in the form of a DC-DC converter.

FIG. 2 shows exemplary circuit components of a push pull implementation of DC-AC converter 6. In this design, current from DC-DC converter 5 is split between inductors 14 and 15 with each branch connected to one side of a parallel resonant arrangement of transmitter coil 7 and a resonant capacitor 16. Switches 17 and 18 are controlled by controller 8 to alternately connect one branch of the parallel resonant circuit to ground. In this embodiment switches 17 and 18 may switch at a constant frequency at or near the resonant frequency of the converter.

Whilst FIG. 2 illustrates a Push Pull converter topology, it is noted that other converter types are applicable operating in buck, boost or buck-boost modes with controllable DC to AC conversion. Such converter could implement, for example, flyback, full bridge, half bridge, etc. topologies in a manner understood by those skilled in the art.

Transmitter side power flow control may be performed in a number of ways. According to one embodiment transmitter side power flow control is effected by controlling the voltage output by controllable DC voltage source 5 based on the current measured by current sensor 9. The magnitude of the current that is drawn by the push-pull circuit is indicative of the apparent load (the real load and the coupling coefficient) on the receiver side. The DC voltage supplied to the push-pull circuit is regulated (by controlling the DC-DC power converter 5) so that the reactive power in the transmitter coil 7 corresponds approximately (i.e., not too high or not too low) to the power being drawn by the load on the IPT receiver 3. This results in more efficient power transfer by dynamically controlling the reactive power. The output voltage of the controllable DC voltage source 5 is adjusted to maintain the output current of the controllable DC voltage source within a prescribed range in accordance with the hysteresis of the output current, preferably within the middle of the range. The output power to be supplied by the IPT transmitter is also preferably set to be greater than the power that is required by the IPT receiver by a prescribed margin between about 5% and about 20% to compensate for any lag in transmitter side control. This is possible because the IPT receiver has power flow control. This method has the advantage that only a current sensor is required.

Another way of performing transmitter side power flow control is for the controller 8 to adjust the output voltage of the controllable DC voltage source in accordance with changes in power supplied based on measurements from the voltage sensor 10 and current sensor 9.

A small delay is inherent between receiving information from the sensors 9 and 10 and adjusting the output voltage of controllable DC voltage source 5 by the controller 8. The Push Pull Converter desirably operates in boost mode to compensate for any power shortages that may incur at the IPT receiver side if a load suddenly changes, as the voltage adjustment will not be instantaneous. The controller 8 may also be pre-programmed to supply an additional amount of reactive power (preferably between about 5% to about 20%) to help compensate for small or instantaneous load changes.

This IPT system design and control method allows control of the amount of reactive power needed at the IPT transmitter coil to deliver sufficient power to the IPT receiver regardless of the load. This ensures high efficiency for any load and the ability to satisfy peak load demands to deal with changes in transmitter and receiver coil coupling due to relative coil movement. The design is relatively simple and robust and avoids the need for communication between an IPT transmitter and an IPT receiver.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power transmitter comprising:
a controllable DC voltage source;
a DC-AC converter that receives a DC power supply from the controllable DC voltage source and generates an AC output waveform to drive a transmitter coil of an inductive power transfer system;
a current sensor for measuring the current supplied by the controllable DC voltage source to the DC-AC converter; and
a controller that adjusts the output voltage of the DC voltage source based on the current measured by the current sensor, so as to maintain the output current of the controllable DC voltage source within a prescribed range.

2. An inductive power transmitter as claimed in claim 1 wherein the controller sets the output voltage of the controllable DC voltage source so as to supply greater power than is required by an inductive power receiver by a prescribed margin.

3. An inductive power transmitter as claimed in claim 2 wherein the prescribed margin is between 5 and 20%.

4. (canceled)

5. An inductive power transmitter as claimed in claim 1 wherein the controller aims to maintain the current in the middle of the range.

6. An inductive power transmitter as claimed in claim 1 including a voltage sensor that senses the output voltage of the controllable DC voltage source.

7. An inductive power transmitter as claimed in 6 wherein the controller adjusts the output voltage of the controllable DC voltage source in accordance with changes in power based on measurements from the voltage sensor and current sensor.

8. An inductive power transmitter as claimed in claim 1 wherein the DC-AC converter operates in boost mode.

9. An inductive power transmitter as claimed in claim 1 wherein the DC-AC converter is a push pull converter.

10. An inductive power transmitter as claimed in claim 1 wherein the DC-AC converter operates at a substantially fixed frequency.

11. An inductive power transmitter as claimed in claim 1 wherein the DC-AC converter incorporates the controllable DC source.

12. An inductive power transmitter as claimed in claim 1 including a transmitter coil connected across the outputs of the DC-AC converter.

13. An inductive power transmitter as claimed in claim 12 including a capacitor in parallel with the transmitter coil.

14. An inductive power transfer system including an inductive power transmitter as claimed in claim 12 and an inductive power receiver having power flow control.

15. An inductive power transfer system as claimed in claim 14 wherein the inductive power receiver includes a DC-DC converter to perform power flow control.

16. A method of controlling an inductive power transmitter supplying power to an inductive power receiver, wherein the inductive power transmitter includes a DC-AC converter driving a transmitter coil from a controllable DC voltage source and wherein the inductive power receiver has power flow control, the method including the steps of:
monitoring the current output by the controllable DC voltage source; and
controlling the voltage output by the controllable DC voltage source based on the monitored current such that the transmitted power is calculated to be a margin greater than the power required by the inductive power receiver.

17. A method as claimed in claim 16 wherein the margin is between 5 and 20%.

18. A method as claimed in claim 16 wherein the output voltage of the controllable DC voltage source is adjusted so as to maintain the output current of the controllable DC voltage source within a prescribed range.

19. A method as claimed in claim 18 wherein the output voltage of the controllable DC voltage source is adjusted so as to maintain the output current of the controllable DC voltage source the middle of the prescribed range.

20. A method as claimed in claim 16 wherein the output voltage of the controllable DC voltage source is adjusted in accordance with changes in power output of controllable DC voltage source.

21. A method as claimed in claim 16 wherein the DC-AC converter operates at a substantially fixed frequency.
